(19) United States
(12) Patent Application Publication
(10) Pub. No.: US 2004/0029562 A1
(43) Pub. Date: Feb. 12, 2004

(54) System and method for securing communications over cellular networks

(75) Inventors: Offer Sharon, Asseret (IL); Meir Lasry, Tel Mond (IL); Victor Sherbinin, Rehovot (IL); Uri Baror, Tel Aviv (IL); M. Ran Bittmann, Tel Aviv (IL)

Correspondence Address: BROWDY AND NEIMARK, P.L.L.C., 624 Ninth Street, N.W., Washington, DC, 20001, US

(73) Assignee: MSAFE LTD., Rehovot (IL)

(21) Appl. No.: 10/224,576

(22) Filed: Aug. 21, 2002

Related U.S. Application Data
(60) Provisional application No. 60/313,486, filed on Aug. 21, 2001.

(51) Int. Cl. H04M 1/66

(52) U.S. Cl. 455/410

(57) ABSTRACT

Disclosed is a mobile unit that includes a dedicated cryptographic processor connected to a main processing unit of the mobile unit and configured to encrypt outgoing packets received from the main processing unit and destined for a remote entity, and configured to decrypt incoming packets transmitted by the remote entity and destined for the main processing unit. In one embodiment of the invention, the dedicated cryptographic processor also functions as a proxy server.

### FIELD OF THE INVENTION

The present invention relates generally to the security of packets transmitted over cellular communication networks. More specifically the invention is in the field of encryption in such communication networks.

### BACKGROUND OF THE INVENTION

Encryption of messages transferred over communication links a practice now commonly employed to overcome security and privacy threats. The earliest standardized method, the DES (Data Encryption Standard) was published by the U.S. National Bureau of Standards in the year 1977, and used to this day. DES and other similar methods are symmetric-key cryptographic schemes in which the encryption and decryption processes utilize the same key. In the DES method the key is a 64-bit binary word, the word is manipulated mathematically with blocks of the message to form encrypted message and encrypting party leave the same key as the receiving and decrypting party. Systems using DES or similar symmetric-key cryptographic methods change the key frequently in order to prevent unwarranted encryption or decryption by third parties. A sending party may use several encryption keys for the same message, for the purpose of sending to each receiving party a different encryption. The DES scheme requires that the common, symmetric key be dispatched by a safe mode. To accomplish that another cryptographic method is typically used, an asymmetric scheme, which is computationally intensive, but has the advantage of a double key system, in which one of the keys is public and can be distributed freely. Since any message encrypted by a public key, can only be decrypted by a matching private key, the public key can be forwarded over insecure channels to as many potential sending parties without appreciable risk.

Reference is made now to FIG. 1, which describes an example of a way in which a symmetric key cryptographic scheme such as DES is used by two entities (sender and receiver) over a communication link implementing the Internet Protocol (“IP”). It is assumed in FIG. 1 for the sake of example that the SSL/TLS protocol is used and that the sender of the (first) message is the initiator of the TCP connection and therefore the client. It follows that the receiver of the message is the server. It is also assumed that the message transferred by the process of FIG. 1 comprises IP packets. In step 10 the client, the activities of which are listed on the right column, establishes a TCP connection with the receiving server. A handshake is performed in step 12 between the sending client and the receiving server in order to set up a security association (SA). The handshaking includes three processes. The first process is authentication, which can take any of several forms in which mutual client and server authentication is performed. Typically however, only server authentication is performed. In the second process, the parties agree as to which type of cryptographic scheme or combination thereof to use. In the third process the symmetric key is passed to the server. However, the symmetric key is encrypted before it is passed to the server, by using the server's public key of the asymmetric scheme. In step 14 the server receives the encrypted symmetric key. In step 16 the message is encrypted by a symmetric scheme that uses the symmetric key, and in step 18 the encrypted message is sent to the server. Meanwhile, the server decrypts the symmetric key in step 20 by the asymmetric scheme using its private key. In step 22 the encrypted message is received, and in step 24 the message is decrypted using the decrypted symmetric key. Of course, the description above depicts only the first message exchanged. The exchange can involve many packets sent in both directions, with each packet encrypted by the sender (client or server) and decrypted by the receiver (client or server), all using the same symmetric key, until a new key exchange step (similar to steps 12, 14, and 20) is initiated.

Communication over cellular networks is becoming a widespread practice. Cellular mobile units are nodes that communicate directly with base stations of the cellular network. The base stations are, often connected to other communication networks such as telephony networks, thus enabling a transfer of the messages between the mobile units arid various networks.

A mobile unit contains, schematically, sub-units as described in FIG. 2, to which reference is now made. Antenna 32 receives and transmits RF signals. A communication interface 34 respectively processes the received signals, and transmits outgoing signals through antenna 32. A main processing unit MPU 36 further processes incoming signals to extract the messages composed of data (as indicated by arrow 38) and/or voice (as indicated by arrow 40. Conversely, processor 36 processes outgoing data, as indicated by arrow 38, and outgoing voice, as indicated by arrow 40.

Messages coming in and going out of a mobile unit of a cellular network go through many nodes of networks while traveling the route between origin and target Unauthorized interception of messages is possible in various portions of the route. For example, the wireless communications between base stations and mobile units of a cellular network are vulnerable to interception by a suitable wireless receiver.

In the prior art, there are system that encrypt messages (voice and/or data) been the mobile unit and the base station at the carrier signal level. An example of such a systems is disclosed in U.S. Pat. No. 5,594,797.

However, the path between base stations and mobile units usually constitutes only a part of the route that a message has to follow between the origin and the target. WAP (wireless application protocol) is a protocol that enables connectivity of the cellular system with the Internet through gateways. Message exchange under the provisions of the IP standard implies that messages travel in packets over multiple-hop routes, Therefore, if the encryption is only between the mobile unit and the base station, the IP packets incoming to or outgoing from the mobile unit are transferred unencrypted between the base station and the message source or destination and can be intercepted. For example, in packet-based networks such as 2.5G and 3G cellular networks, the routers in the path between the base station and a server at the Internet, or the core IP network of the operator, can easily open any packet.

In the prior art there are also systems for encryption performed within a communication network. For example, in U.S. Pat. No. 6,097,817 to Bilgic et al, encryption over a wireless trunk is performed in a network device. In U.S. Pat. No. 6,185,680 to Shimbo et al. encryption is performed at a virtual private network (“VPN”) gateway.

However, these systems where encryption is performed in the network do not provide protection for the messages incoming to or outgoing from the mobile unit after or before the point in the network where the decryption or encryption is performed.

There are two prior-art solutions that provide encryption protection for the entire route between the mobile unit and a remote source or destination of the message. The first solution involves employing a cryptographic scheme, which is associated with the application itself. This way, for a mobile unit that uses two applications, two cryptographic software engines are used as well. The processing power for each separate encryption software engine burdens the MPU. In addition, an application with a weak encryption engine can compromise the entire mobile unit. A second solution involves providing encryption capabilities in one or more smart cards located in the mobile unit. Examples of smart cards include inter-alia: wireless identification module (WIM), subscriber identity module (SIM), universal subscriber identity module (USIM), and SWIM (SIM and WIM together). This solution is typically power inefficient and slows down communications because the interface between the mobile unit MPU and the card is typically much slower than the communication interface. In addition, because the smart card is not normally in the path of the traffic, any data that needs to be encrypted must first be sent to the smart card, encrypted, and then returned to the MPU.

What is needed in the art is an improved system and method that provides encryption protection to a message comprising one or more packets for the entire route between the mobile unit and the remote destination/source of the message.

### SUMMARY OF THE INVENTION

Herein below, the term “security association” (SA) is used to denote an association, which is set up between the mobile unit and a remote entity, to allow encrypted packets to be exchanged during a particular session on a VPN (IPsec protocol), during a particular TCP connection (SSL/TLS protocol), or more generally, during any particular encrypted packet exchange involving a protocol which allows encryption. The remote entity can be the initiator of the exchange (“remote initiating entity”) or can acquiesce to the exchange (“remote responding entity”). Examples of a remote entity include inter-alia a server, for example an Internet server, or another mobile unit with which the SA is established without a server intermediary.

According to the present invention, there is provided a mobile unit configured to securely transmit and receive packets, comprising: a dedicated cryptographic processor connected to a main processing unit of the mobile unit and configured to encrypt outgoing packets received from the main processing unit and destined for a remote entity, and configured to decrypt incoming packets transmitted by the remote entity and destined for the main processing unit.

According to the present invention, there is also provided a mobile unit configured to securely transmit and receive packets, comprising: a dedicated cryptographic processor connected to a communication interface of the mobile unit and to a main processing unit of the mobile unit, the dedicated processor configured to participate in establishing a security association SA with a remote entity, and configured to encrypt outgoing packets received from the main processing unit and destined for the remote entity during the SA, and configured to decrypt incoming packets, received from the remote entity during the SA and destined for the main processing unit.

According to the present invention there is further provided a method for securely transferring packets from a mobile unit to a remote entity, comprising: routing at least one packet for which encryption is desired from a main processing unit in the mobile unit to a dedicated cryptographic processor in the mobile unit; the dedicated processor encrypting the at least one routed packet; and the mobile unit transmitting the at least one encrypted packet to the remote entity during a security association SA established between the mobile unit and the remote entity.

According to the present invention there is still further provided a method for securely transferring packets from a mobile unit to a remote entity, comprising: routing at least one packet for which encryption is desired from a main processing unit in the mobile unit to a dedicated cryptographic processor in the mobile unit; the dedicated processor encrypting the at least one routed packet; and the dedicated processor transmitting the at least one encrypted packet to the remote entity during a security association SA established between the dedicated processor and the remote entity.

According to the present invention, there is provided a method for securely receiving packets by a mobile unit from a remote entity, comprising: the mobile unit receiving at least one encrypted packet from a remote entity during a security association SA established between the mobile unit and the remote entity; a dedicated cryptographic processor in the mobile unit decrypting the at least one received packet; and the dedicated cryptographic processor transferring the at least one decrypted packet to a main processing unit in the mobile unit.

According to the present invention there is also provided a method for securely receiving packets by a mobile unit from a remote entity, comprising: a dedicate cryptographic processor in the mobile unit receiving at least one encrypted packet from a remote entity during a security association SA established between the dedicated cryptographic processor and the remote entity; the dedicated cryptographic processor decrypting the at least one received packet; and the dedicated cryptographic processor transferring the at least one decrypted packet to a main processing unit in the mobile unit.

According to the present invention, there is further provided a mobile unit configured to secure data within a mobile unit, comprising: a dedicated cryptographic processor connected to a main processing unit of the mobile unit and configured to encrypt data blocks or streams received from the main processing unit and destined for the main processing unit, and configured to decrypt data blocks or streams received from the main processing unit and destined for the main processing unit, wherein the data blocks or streams are for internal use of at least one application running on the mobile unit.

According to the present invention, there is still further provided a method for securing data within a mobile unit comprising: routing at least one data block or stream for which encryption or decryption is desired from a main processing unit in the mobile unit to a dedicated cryptographic processor in the mobile unit; the dedicated processor encrypting or decrypting the at least one routed data block or stream; and the dedicated processor transferring the at least one encrypted or decrypted data block or stream to the main processing unit, wherein the at least one encrypted or decrypted data block or stream is for internal use of at least one application running on the mobile unit.

### BRIEF DESCRIPTION OF THE DRAWINGS

The invention is herein described, by way of example only, with reference to the accompanying drawings, wherein:

FIG. 1 is a chart describing the sequence of steps employed in currently available systems for sending securely messages over packet-switching communication networks;

FIG. 2 is a block diagram description of the main architectural elements of a prior art mobile unit of a cellular network;

FIG. 3 is a block diagram description of the main components of a dedicated cryptographic processor, in accordance with a preferred embodiment of the present invention;

FIG. 4 is a block diagram description of a mobile unit within which a dedicated cryptographic processor is deployed, in accordance with a preferred embodiment of the present invention;

FIG. 5 is a flow chart schematically illustrating the chain of events taking place inside a mobile unit of the invention and a remote responding entity, in response to a service request by the mobile unit, in accordance with a preferred embodiment of the present invention;

FIG. 6 is a flow chart schematically illustrating the chain of events taking place inside a mobile unit of the invention and at a remote initiating entity, in response to a service request by the remote initiating entity, in accordance with a preferred embodiment of the present invention;

FIG. 7 is a block diagram description of a mobile unit within which a dedicated cryptographic processor is deployed, in accordance with another preferred embodiment of the present invention;

FIG. 8 is a flow chart schematically illustrating the chain of events taking place inside a mobile unit of the invention and a remote responding entity, in response to a service request by the mobile unit, in accordance with another preferred embodiment of the present invention;

FIG. 9 is a flow chart schematically illustrating the chain of events taking place inside a mobile unit of the invention and at a remote initiating entity, in response to a service request by the remote initiating entity, in accordance with another preferred embodiment of the present invention;

FIG. 10 is a block diagram of a mobile unit including at least one smart card, in accordance with a preferred embodiment of the present invention;

FIG. 11 is a block diagram of a mobile unit including at least one smart card, in accordance with another preferred embodiment of the present invention; and

FIG. 12 is a block diagram of a mobile unit within which a dedicated cryptographic processor is deployed, in accordance with another aspect of the present invention.

### DESCRIPTION OF THE PREFERRED EMBODIMENTS

A preferred embodiment of the current invention secures packets for the entire route between mobile unit and a remote entity. In the description below, the protocol is assumed to be the Internet Protocol (“IP”), and therefore outgoing messages, incoming messages, responses, and encryption keys from and to the mobile unit, are assumed to comprise IP packets. However in other preferred embodiments, other packet-based protocols may be substituted, with outgoing messages, incoming messages, responses, and encryption keys from and to the mobile unit comprising packets conforming to the other packet based protocols.

The principles and operation of an encryption system and method according to the present invention may be better understood with reference to the drawings and the accompanying description. All examples given below are non-limiting illustrations of the invention described and defined herein.

A feature of the present invention is the inclusion of a dedicated cryptographic processor (DCP) in the mobile unit. The DCP functions as a hardware accelerator for the encryption/decryption operation, which is controlled by a software application in the main processing unit MPU). For example, a browser application in the MPU may desire DCP encryption and decryption of packets sent to and received from an Internet server.

An encryption engine and parameters are determined during negotiations (handshake) between the mobile unit and the remote entity. For example, in the common encryption protocols of SSL/TLS or IPsec, the encryption scheme (for example DES) and/or the associated parameters (for example 128-bit keys) can be negotiated. Note that typically although not necessarily, the security level associated with a particular encryption/decryption is a function of either the specific engine used, as is correlated to the level of security associated with that engine, or the length of the key associated with that cryptographic engine. Typically, although not necessarily, the same encryption scheme is used for each packet, which is part of a single security association SA.

Preferably, a desired security level of the encryption can be chosen by the user of the mobile unit. For example the user may choose a security level 2 out of a scale of 3 by adjusting a control setting of the mobile unit. The chosen security level is then taken into account during the negotiations and influences the determination of engine and parameters for outgoing packets and/or incoming packets.

In one preferred embodiment, the DCP also functions as a proxy server of a packet-based network. In this preferred embodiment the DCP actively participates in establishing and maintaining the SA with the remote entity (i.e. the DCP participates either as the initiator or respondent). In another preferred embodiment, the DCP is responsible only for accelerating the encryption/decryption. In this other preferred embodiment, an SA is established conventionally between the software application in the MPU and the remote entity. In yet another preferred embodiment, in some instances the DCP in the mobile unit also functions as a proxy server while in other instances the DCP is responsible only for accelerating the encryption/decryption.

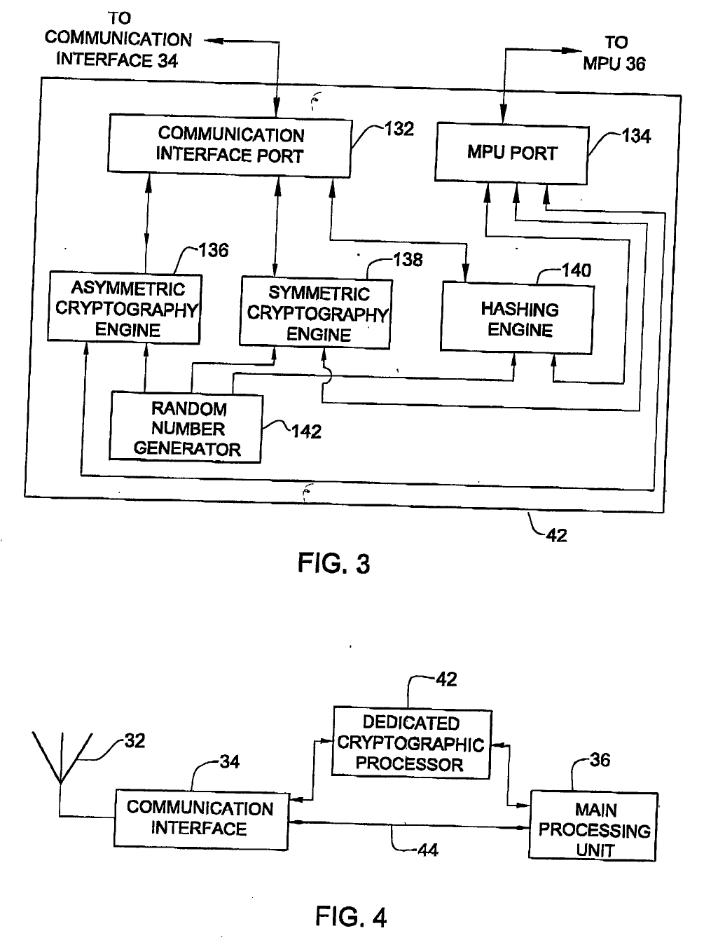

FIG. 3, to which reference is now made, describes schematically the structural elements of a DCP 42, in accordance with preferred embodiments of the present invention. In preferred embodiments where DCP 42 functions in some or all instances as a proxy server, DCP 42 includes an optional communication interface port 132 connected to communication interface 34 for sending encrypted packets, and receiving encrypted packets.

DCP 42 also includes an MPU port 134 connected to an MPU 36. In preferred embodiments or instances where DCP 42 functions also as a proxy server, raw (unencrypted) packets are received through MPU port 134 and decrypted packets are sent through MPU port 134. In preferred embodiment or instances where DCP 42 does not participate in the establishment of the SA, raw packets or encrypted packets are received through MPU port 134 and encrypted packets or decrypted packets are sent through MPU port 134 after being processed by DCP 42.

In a preferred embodiment, the software for driving the DCP hardware is embedded in non-volatile memory attached to the hardware and is therefore considered herein below as firmware. The firmware of DCP 42 includes cryptography engines grouped into several categories. Asymmetric cryptography engine group 136 contains modules such as RSA, ECC, and DH. Symmetric cryptography engines group 138 contains modules such as DES, AES, 3DES, RC4, and RC5. Hashing engine cryptography group 140 contains hashing algorithms such as SH1 and MD5, used for verifying data integrity, typically in conjunction with a symmetric cryptography engine. A random number generator 142, supplies random numbers, for generation of keys to the various cryptography engines.

In most cases only the payload of the outgoing or incoming packets is subjected to encryption or decryption by DCP 42. In other cases, encapsulation is used, i.e. the header of a packet is also encrypted and then a new unencrypted header is added so that the packet can be routed.

A preferred embodiment of a mobile unit including a DCP 42 functioning also as a proxy server, is illustrated in. FIG. 4. DCP 42 is disposed between communication interface 34 and MPU 36. The signals between communication interface 34 and MPU 36 are routed into two different routes. Some signals, such as non-packetized voice signals incoming from communication interface 34 are routed directly to main processing unit 36. Some signals, such as containing application-encrypted packets outgoing from MPU 36 are not processed by DCP 42 and are routed directly to communication interface 34. Incoming and outgoing signals directly communicated between communication interface 34 and MPU 36 are designated by double-headed arrow 44. Packets, both incoming and outgoing, destined to be processed by DCP 42, are routed through DCP 42. Encrypted incoming packets arrive from communication interface 34 at communication interface port 132 (FIG. 3) of DCP 42 and outgoing raw packets arrive at DCP 42 from MPU 36 at MPU port 134 (FIG. 3).

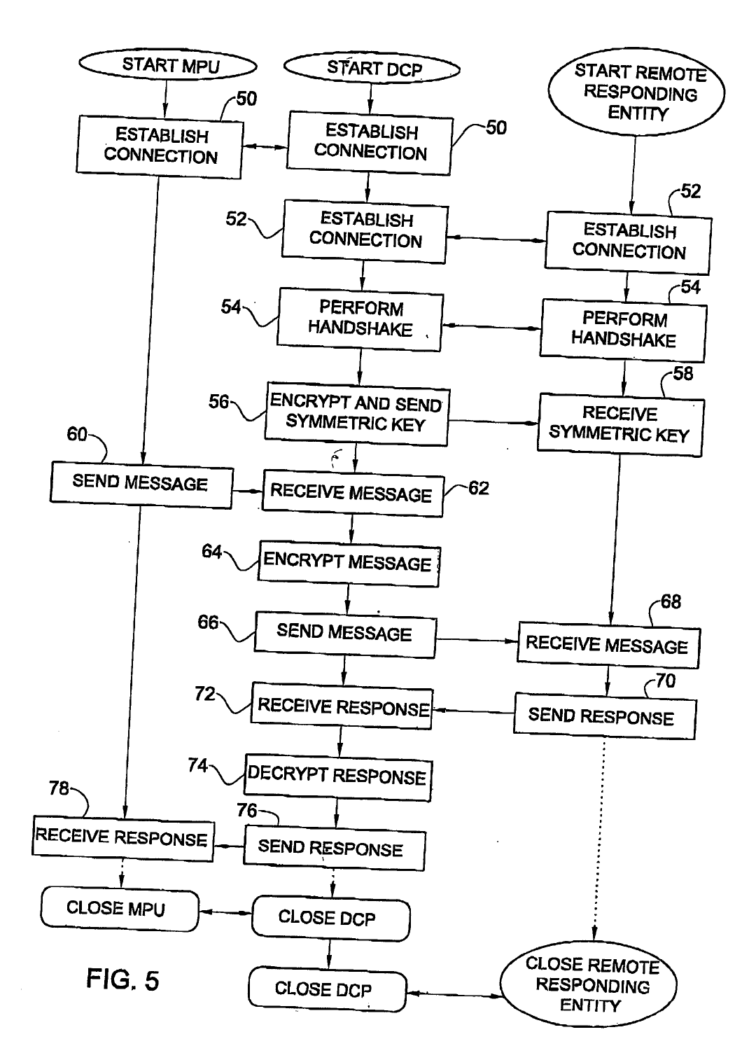

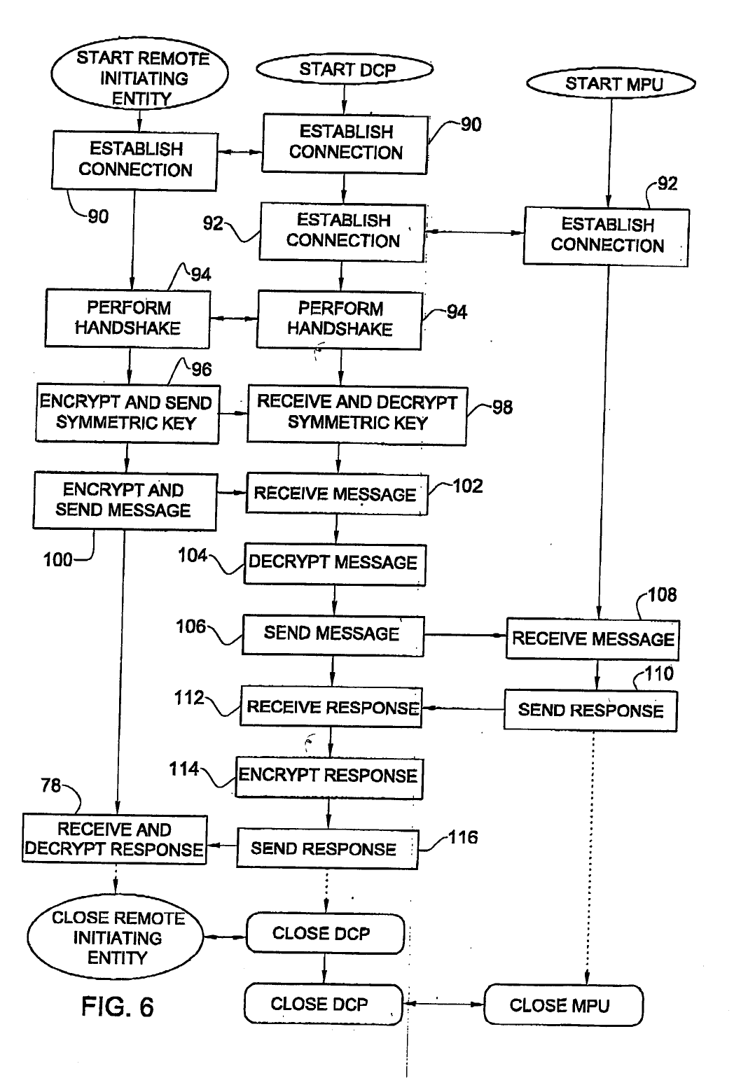

In the preferred embodiments illustrated in FIG. 5 and FIG. 6, DCP 42 functions as a proxy server in a packet-based network, and as such DCP 42 facilitates performing a secure transaction with a mobile unit.

Reference is made to the flow chart of FIG. 5 that illustrates the process taking effect within the mobile unit, which initiates an exchange with a remote responding entity, in accordance with a preferred embodiment of the invention. For the sake of example, it is assumed that the SSL/TLS protocol is being used for the communication between the mobile unit and the remote entity. For brevity FIG. 5 does not detail the decryption of the received key and message and encryption of the sent response taking place at the remote entity side, depicted in the right column. MPU 36 initiates a message transfer and to that end MPU 36 establishes a TCP connection in step 50 with DCP 42. Furthermore, the message transfer involves also DCP 42 establishing a TCP connection with the remote entity at step 52. A mutual handshake is performed between DCP 42 and the remote entity at step 54 in order to set up an SA. In the handshaking event three processes take place. First, authentication is performed. Typically, although not necessarily, the remote responding entity is a web server, and only its authentication is performed. Second, the encryption scheme is resolved, and third DCP 42 sends an appropriate key (herein below referring to a single key or a plurality of keys) to the remote entity, which takes place in step 56. Typically although not necessarily, a symmetrical scheme is used, to which end a symmetrical key is sent to the remote entity. However the symmetrical key must be encrypted before the symmetrical key is communicated, and this is usually done using a public key of the receiving asymmetrical encryption engine. The reception of encrypted symmetric key by the remote entity takes place in step 58. Then, in step 60, the MPU sends a raw (unencrypted) message to DCP 42, which receives the raw message in step 62. Then, in DCP 42, at step 64 the message is encrypted, typically by a symmetric key engine, and is subsequently sent at step 66 from communication interface 34, to be received at step 68 by the remote entity. In step 70, the remote entity sends a response to DCP 42, which receives the response at step 72. The response is decrypted at step 74 in DCP 42, and the decrypted response is sent to MPU 36 at step 76. The decrypted response is received in MPU 36 at step 78. Steps 60, 62, 64, 66, 68, 70, 72, 74, 76, and 78, can recur automatically until the SA comes to an end. Terminating the SA takes place as soon as one side terminates the TCP connection, for example, MPU 36 terminating the connection with DCP 42, and DCP 42 subsequently terminating the connection with the remote entity.

With respect to a remote entity initiating the message transfer, generally the sequence of steps involved is similar to the one described above, with some exceptions. This sequence is illustrated in the chart of FIG. 6 to which reference is now made. In step 90 the remote initiating entity initiates a message transfer and establishes a TCP connection at step 90 with DCP 42. Then, a TCP connection is established between DCP 42 and MPU 36 at step 92. At steps 94, a handshaking takes place between the remote entity and DCP 42 in order to set up an SA. As part of the handshake, the remote entity encrypts and sends the symmetric key at step 96. At step 98 DCP 42 receives the symmetric key and decrypts the symmetric key. Then in step 100, the remote entity encrypts the message by the same symmetric key provided earlier to DCP 42, and sends the encrypted message to DCP 42. DCP 42 receives the encrypted message at step 102 and decrypts the message at step 104 using the symmetric key. The decrypted message is sent to MPU 36 at step 106, and received at the MPU at step 108. In step 110 a response is sent to DCP 42, where the response is received at step 112. In step 114, the response it encrypted and sent to the remote entity at step 116. The encrypted response is received by the remote entity at step 118. Steps 100, 102, 104, 106, 108, 110, 112, 114, 116 and 118 can recur automatically until the SA comes to an end. Terminating the SA takes place as soon as one side terminates the TCP connection, for example, the remote entity terminating the connection with DCP 42, and DCP 42 subsequently terminating the TCP connection with MPU 36.

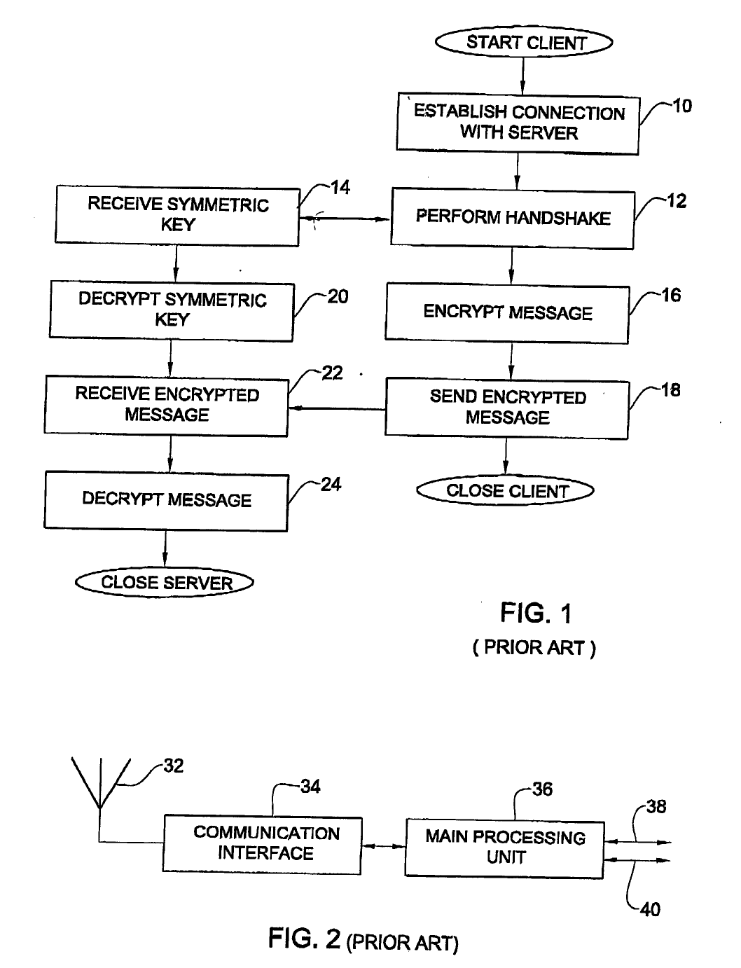

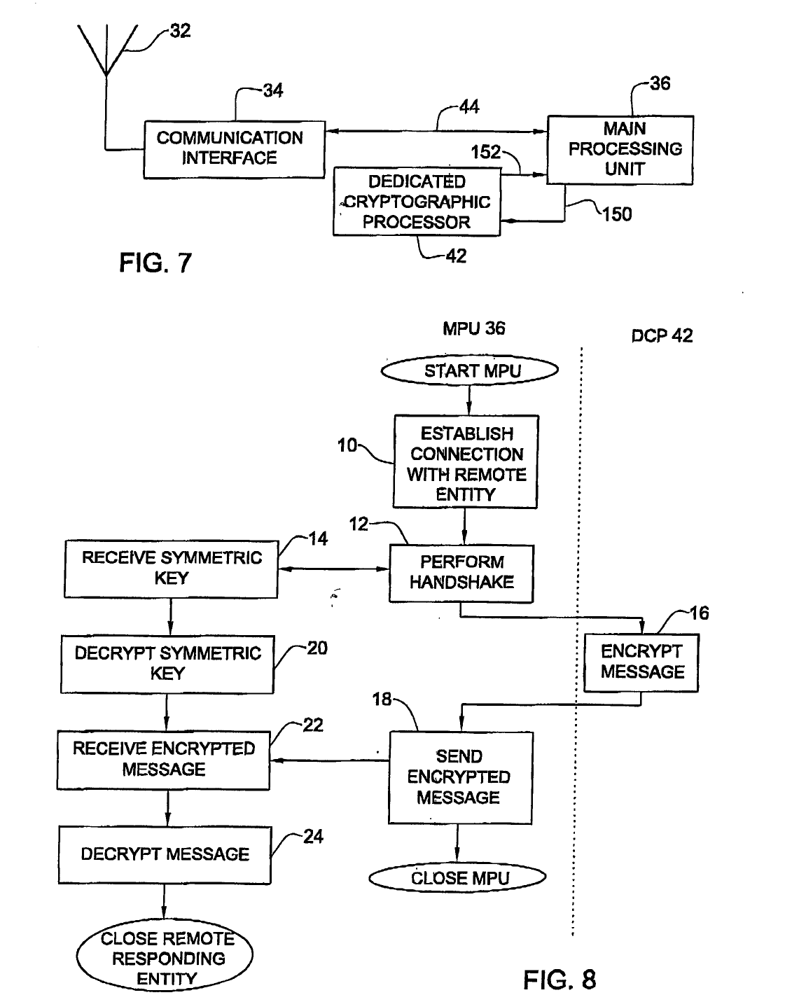

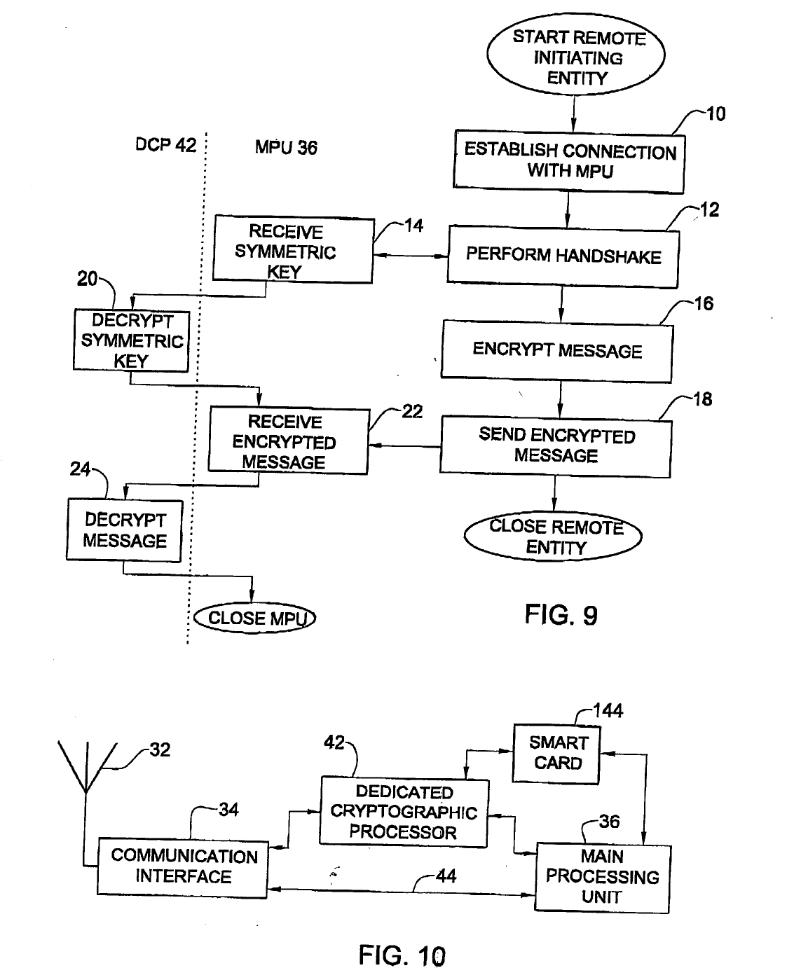

FIG. 7 illustrates a preferred embodiment of a mobile unit including a DCP 42 responsible for encryption and deception, where the SA is set up conventionally by an application in MPU 36. Reference is also made to FIGS. 8 and 9, which are adaptations of prior art FIG. 1, to show encryption/decryption by DCP 42 in accordance with a preferred embodiment of the present invention. For simplicity of drawing FIGS. 8 and 9 only illustrate a first message in the exchange destined to be encrypted or decrypted and omit certain steps illustrated in previous figures.

In FIG. 8, it is assumed that the mobile unit initiates the exchange and therefore the mobile unit performs the tasks on the right and the remote responding entity performs the tasks on the left. Steps 10 and 12 are performed in the mobile unit by the associated application in MPU 36. MPU 36 then transfers to DCP 42 the raw (unencrypted) message and the requested operation, for example encrypt using the ECC scheme, which in this example is assumed to have been chosen during negotiations with the remote mobile in step 12. MPU 36 can also transfer the key for the operation to DCP 42 or alternatively, the key can be a-priori stored in DCP 42. The transfer from MPU 36 to DCP 42 is depicted by arrow 150 in FIG. 7. In step 16, the message is encrypted by DCP 42, and transferred from DCP 42 to MPU 36 (arrow 152). In stop 18, MPU 36 transfers the encrypted message to communication interface 34 (double-headed arrow 44) for transmission to the remote entity.

Referring now to FIG. 9, if the remote entity initiates the exchange, the mobile unit performs the tasks on the left and the remote entity performs the tasks on the right. In step 14, the symmetric key is received from the remote entity and transferred from communication interface 34 to MPU 36 (double-healed arrow 44 in FIG. 7). The received key is transferred from. MPU 36 to DCP 42 for decryption (arrow 150). DCP 42 decrypts the key in step 20. In step 22, the encrypted message is received from the remote entity and transferred from communication interface 34 to MPU 36 (double arrow 44). The encrypted message is then transferred from MPU 36 to DCP 42 (arrow 150) along with the desired operation, for example decrypt the message, using ECC. In step 24, the message is decrypted by DCP 42, and transferred from DCP 42 to MPU 36 (arrow 152).

In a preferred embodiment where for some messages, DCP 42 acts as a proxy server whereas for other messages the SA is set up conventionally by the associated application in MPU 36, the mobile unit incorporating DCP 42 allows both message flows similar to the flows illustrated in FIG. 4 and message flows similar to the flows illustrated in FIG. 7.

In another preferred embodiment of the invention, the mobile unit incorporating DCP 42 includes one or more smart cards 144, as in the GSM system. Typically, although not necessarily, smart cards 144 are installed inside the mobile unit, but are removable and replaceable.

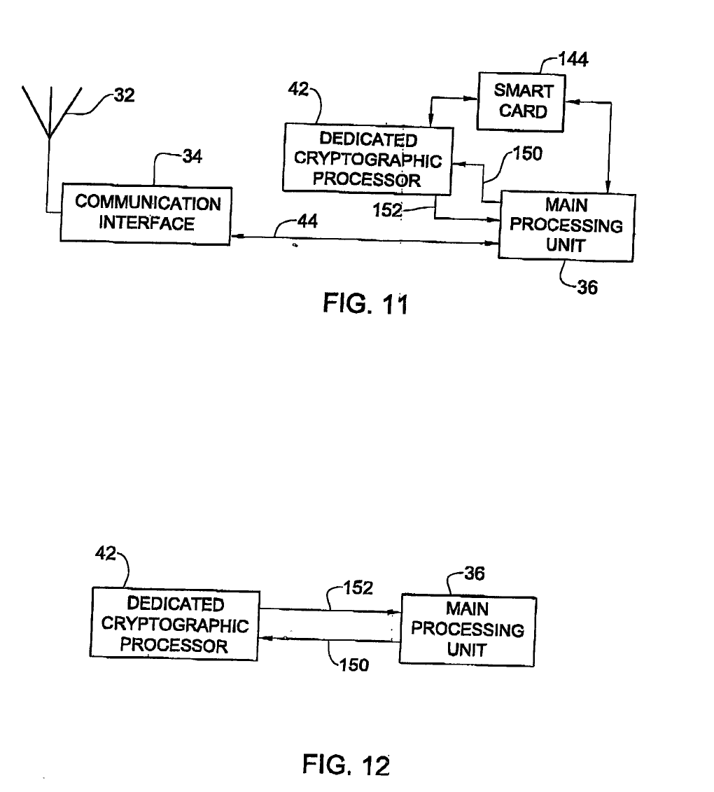

Refer to FIG. 10 and FIG. 11. FIG. 10 illustrates a preferred embodiment with smart card(s) 144 where DCP 42 acts a proxy server and FIG. 11 illustrates a preferred embodiment with smart card(s) 144 where the SA is established conventionally by the associated application in MPU 36. Smart card(s) 144 apart from containing the user's identity arguments may also be used to keep some of the cryptographic keys for use by DCP 42, MPU 36, and/or use by the smart card(s) 144 itself. For example, a particular smart card may contain asymmetric private keys and symmetric keys used by DCP 42 in performing the methods illustrated by FIGS. 5, 6, 8 and 9. Communication between DCP 42 and smart card(s) 144 may follow standard protocols used by MPU 36 to communicate with smart card(s) 144. If there are a plurality of smart card(s) 144 in a mobile unit, the decision rules for choosing from which smart card 144 (SIM or WIM for example) to obtain the key for a particular message are typically, although not necessarily, included in the software in DCP 42. The choice typically, although not necessarily, depends on which application in MPU 36 is related to the message and/or which remote entity is a party to the SA.

It should be understood that the invention is not bound to the protocols and/or encryption schemes described above. For example, in alternative preferred embodiments to those illustrated other protocols, and/or other encryption schemes can be substituted, mutatis mutandis. As another example, in alternative preferred embodiments, the responding entity may send the symmetric key, the symmetric key may be generated by both the initiating and responding entity, or the symmetric key may be sent by a key distribution center. These alternative methods of key transfer are known in the art.

In another aspect of the invention, DCP 42 can be used to secure a data file for use by an application running on the mobile unit. Refer to FIG. 12. In accordance with this aspect of the invention, MPU 36 transfers unencrypted data blocks or streams or encrypted data blocks or streams to DCP 42 (arrow 150) and after processing, DCP 42 transfers encrypted or decrypted data blocks or streams respectively to MPU 36 (arrow 152). In this aspect of the invention, the data blocks or streams encrypted or decrypted by DCP 42 neither originate from a remote entity nor are destined for the remote entity.

In some preferred embodiments of the invention, DCP 42 can be used to secure data blocks or streams for internal use as well as outgoing/incoming packets.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While the invention has been described with respect to a limited number of embodiments, it will be appreciated that many variations, modifications and other applications of the invention may be made.

1. A mobile unit configured to securely transmit and receive packets, comprising: a dedicated cryptographic processor connected to a main processing unit of the mobile unit and configured to encrypt outgoing packets received from said main processing unit and destined for a remote entity, and configured to decrypt incoming packets transmitted by said remote entity and destined for said main professing unit.

2. The mobile unit of claim 1, wherein said dedicated cryptographic processor is also connected to a communication interface of the mobile unit and said dedicated cryptographic processor is configured to participate in establishing a security association with said remote entity for exchanging encrypted packets.

3. The mobile unit of claim 1, further comprising at least one smart card configured to store at least one cryptographic key for use by said dedicated cryptographic processor.

4. The mobile unit of claim 1, wherein said dedicated cryptographic processor includes at least one cryptographic engine.

5. The mobile unit of claim 1, wherein the packets are Internet Protocol packets.

6. A mobile unit configured to securely transmit and receive packets, comprising: a dedicated cryptographic processor connected to a communication interface of the mobile unit and to a main processing unit of the mobile unit, said dedicated processor configured to participate in establishing a security association SA with a remote entity, and configured to encrypt outgoing packets received from said main processing unit and destined for said remote entity during said SA, and configured to decrypt incoming packets, received from said remote entity during said SA and destined for said main processing unit.

7. A method for securely transferring packets from a mobile unit to a remote entity, comprising:
routing at least one packet for which encryption is desired from a main processing unit in the mobile unit to a dedicated cryptographic processor in the mobile unit;
said dedicated processor encrypting said at least one routed packet; and
the mobile unit transmitting said at least one encrypted packet to said remote entity during a security association SA established between the mobile unit and said remote entity.

8. The method of claim 7, wherein said SA is established between said dedicated cryptographic processor and said remote entity, and wherein said dedicated cryptographic processor transmits said at least one encrypted packet to said remote entity during said SA.

9. The method of claim 7, wherein for at least part of said at least one routed packet, only a payload is encrypted by said dedicated cryptographic processor.

10. The method of claim 7, further comprising: adjusting said encrypting by said dedicated processor in accordance with a security level control setting of the mobile unit and in accordance with negotiations conducted between the mobile unit and said the remote entity when establishing said security association.

11. The method of claim 7, further comprising: having a symmetric encryption key securely transferred between the mobile unit and said remote entity.

12. The method of claim 7, wherein said at least one packet is an Internet Protocol packet.

13. A method for securely transferring packets from a mobile unit to a remote entity, comprising:
routing at least one packet for which encryption is desired from a main processing unit in the mobile unit to a dedicated cryptographic processor in the mobile unit;
said dedicated processor encrypting said at least one routed packet; and
said dedicated processor transmitting said at least one encrypted packet to said remote entity during a security association SA established between said dedicated processor and said remote entity.

14. A method for securely receiving packets by a mobile unit from a remote entity, comprising:
the mobile unit receiving at least one encrypted packet from a remote entity during a security association SA established between the mobile unit and said remote entity;
a dedicated cryptographic processor in the mobile unit decrypting said at least one received packet; and
said dedicated cryptographic processor transferring said at least one decrypted packet to a main processing unit in the mobile unit.

15. The method of claim 14, wherein said SA is established between said dedicated cryptographic processor and said remote entity, and wherein said dedicated cryptographic processor receives said at least one encrypted packet from said remote entity during said SA.

16. The method of claim 14, wherein for at least part of said at least one received packet, only a payload is decrypted by said dedicated cryptographic processor.

17. The method of claim 14, further comprising: having a symmetric encryption key securely transferred between the mobile unit and said remote entity.

18. The method of claim 14, wherein said at least one packet is an Internet Protocol packet.

19. A method for securely receiving packets by a mobile unit from a remote entity, comprising:
a dedicate cryptographic processor in the mobile unit receiving at least one encrypted packet from a remote entity during a security association SA established between said dedicated cryptographic processor and said remote entity;
said dedicated cryptographic processor decrypting said at least one received packet; and
said dedicated cryptographic processor transferring said at least one decrypted packet to a main processing unit in the mobile unit.

20. A mobile unit configured to secure data within a mobile unit, comprising: a dedicated cryptographic processor connected to a main processing unit of the mobile unit and configured to encrypt data blocks or streams received from said main processing unit and destined for said main processing unit, and configured to decrypt data blocks or streams received from said main processing unit and destined for said main processing unit, wherein said data blocks or streams are for internal use of at least one application running on the mobile unit.

21. A method for securing data within a mobile unit, comprising:
routing at least one data block or stream for which encryption or decryption is desired from a main processing unit in the mobile unit to a dedicated cryptographic processor in the mobile unit;
said dedicated processor encrypting or decrypting said at least one routed data block or steam; and
said dedicated processor transferring said at least one encrypted or decrypted data block or stream to said main processing unit, wherein said at least one encrypted or decrypted data block or stream is for internal use of at least one application running on the mobile unit.

22. A computer product comprising computer readable medium storing program code for performing all the steps of claim 7 when said program is run on a computer.

23. A computer product comprising computer readable medium storing program code for performing all the steps of claim 13 when said program is run on a computer.

24. A computer product comprising computer readable medium storing program code for performing all the steps of claim 14 when said program is run on a computer.

25. A computer product comprising computer readable medium storing program code for performing all the steps of claim 19 when said program is run on a computer.

26. A computer product comprising computer readable medium storing program code for performing all the steps of claim 21 when said program is run on a computer.
